(19) United States
(12) Patent Application Publication
(10) Pub. No.: US 2017/0331312 A1
(43) Pub. Date: Nov. 16, 2017

(54) RESETTING AN INDUCTIVE CHARGING DEVICE

(71) Applicants: Dinu Petre Madau, Canton, MI (US); Gary Edward Zack, Novi, MI (US)

(72) Inventors: Dinu Petre Madau, Canton, MI (US); Gary Edward Zack, Novi, MI (US)

(21) Appl. No.: 15/150,642

(22) Filed: May 10, 2016

(51) Int. Cl. H02J 7/02; H02J 7/04

(52) U.S. Cl. CPC H02J 7/025; H02J 7/027; H02J 7/041

(57) ABSTRACT

Systems, methods, and modification for restarting an inductive charging operation for an inductive charging device are disclosed herein. The systems, methods, and modifications employ measurements of maximum oscillation voltages (MoV) values, and employs differences in the measured maximum oscillation voltage to instigate a restart charging signal for the inductive charging device.

### BACKGROUND

Inductive charging allows a power source to be electrically coupled to a receiving device without the use of wires and connectors. Inductive charging may be referred to with other terminology, such as wireless charging, Qi charging, non-contact charging, and the like.

These sorts of charging environments are preferred, as they allow for charging without the complication of wires and other elements. Further, a user merely has to place the device to charge on a surface, thus obviating the process of connecting wires. Thus, inductive charging devices are being implemented in a whole variety of contexts/environments, such as homes, places of business, and even in vehicles.

The inductive charging systems employ a coil on the transmission side (TX) and a coil on the reception side (RX). As electric current is driven through the TX side, the electric current turns into magnetic energy, which resonates on the coils in the RX side. Thus, energy is transferred from a source to a receiver.

In recent years, the inductive charging systems have incorporated various technologies to ensure safe charging in the presence of foreign objects. One such technique is foreign object detection (FOD). Certain objects may initially appear to the transmission side as an object capable of receiving inductive charge. These objects, for example, coins, paper clips, head phones, and the like, may include metal, and thus, appear to be capable of receiving wireless charge. As such, various systems have been disclosed to detect these foreign objects.

One such system is the detection of maximum oscillation voltage (MoV). The MoV is the feedback voltage on the coil. You inject a short energy pulse (ping) in the coil and then read the MoV level on the feedback line. By observing the MoV signal, a transmitter may be able to determine whether the object being placed on a wireless charging pad is associated with a foreign object or a chargeable device.

FIG. 1 illustrates an example of an inductive charging system 100 according to a prior art implementation. As shown in FIG. 1, the inductive charging system 100 includes a TX device 110 and an RX device 121. The TX device 110 is coupled to a power source, such as a battery or the like. The TX device 110 is configured to electrically couple the battery/charger to a mobile device (or devices) 120, independent of wires or any sort of mechanical fastening or coupling.

Also provided is a charging control processor (CCP) 150, which may be a processor or an encoded logic device associated with the TX device 110. The CCP 150 determines whether the TX device 110 is turned on and delivers power.

The device 120 being powered may have an embedded RX device 121. As shown in FIG. 1, the TX device 110 includes a transmitting coil 111 that is configured to deliver power to a receiving coil 122 (as shown in blown-up view 130).

A sample of the CCP 150's implementation is also shown in FIG. 1. The CCP 150 includes an MoV detector 151, a charging starter 152, and a FoD detector 153. The MoV detector 151 determines the amount of MoV detected when a device 120 is placed onto the TX device 110. Once the MoV level is received, the amount may be propagated to other control systems. A ping may be generated periodically, thereby leading to a periodic measurement (based on the application). If the MoV is within a specific range, a device may be detected, and thus, charging may commence (i.e. controlled via the charging starter 152). The charging starter 152 may be a controller or circuit that allows power to be propagated via the TX device 110.

The MoV detector 151 may periodically detect other conditions, such as a foreign object being placed on the TX device 110. Once a MoV detector 151 detects an indication that a foreign object is on the TX device 110, the FoD detector 153 communicates a signal to the TX device 120. Thus, when a foreign object is placed on the TX device 110, the FoD 112 mode may be activated (and in some examples, may be indicated with a light or other indication), based on the receiving of the signal from the FoD detector 153.

In certain situations, if the RX device 121 is sufficiently moved while charging, the charging control/monitor may detect a charging abnormality that can stop charging and prevent resumption of charging even if the device is moved back to the original location. In order for a user to restart wireless charging, current inducting charging devices require the user to remove the RX device, and replace it on the wireless charging pad.

### SUMMARY

The following description generally relate to inductive charging. Exemplary embodiments may also be directed to the systems and methods for resetting an inductive charging device, and inductive charging devices incorporating said concepts.

In one of the systems disclosed herein, A system for resetting an inductive charging device is provided herein. The system includes a maximum oscillation voltage (MoV) circuit configured to receive an MoV measurement from the inductive charging device; a difference processor configured to detect a difference from an initial MoV measurement and a subsequent MoV measurement from the MoV circuit; a reset communication configured to electrically communicate a reset signal to the inductive charging device based on the detected difference, wherein the inductive charging device is communicatively coupled to a charge controlling processor (CCP), the CCP including a foreign object detection circuit configured to detect a foreign object placed on the inductive charging device based on the MoV measurement, the inductive charging device is configured to charge a receiving device in response to the receiving device being in alignment, and the inductive charging device is configured to stop charging the device based on mis-alignment and/or the detected foreign object.

It is to be understood that both the foregoing general description and the following detailed description are exemplary and explanatory and are intended to provide further explanation of the invention as claimed. Other features and aspects will be apparent from the following detailed description, the drawings, and the claims.

### DESCRIPTION OF THE DRAWINGS

The detailed description refers to the following drawings, in which like numerals refer to like items, and in which:

FIG. 1 illustrates an example of an inductive charging system according to a prior art implementation.

FIG. 2 illustrates an example of employing maximum oscillation voltage (MoV) to detect phone and/or foreign objects on an inductive charging device.

FIG. 3 illustrates an example of a system for resetting an inductive charging device.

FIG. 4 illustrates an example of a lookup table implemented with the system in FIG. 3.

FIGS. 5(a) and (b) illustrate an example of a method for implementing the system in FIG. 3, and a set of waveform signals explaining the method.

FIGS. 6(a) and (b) illustrate another example of a method for implementing the system in FIG. 3, and a set of waveform signals explaining the method.

FIGS. 7(a)-(c) illustrate an example of an inductive charging device employing the aspects of system in FIG. 3.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of one or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

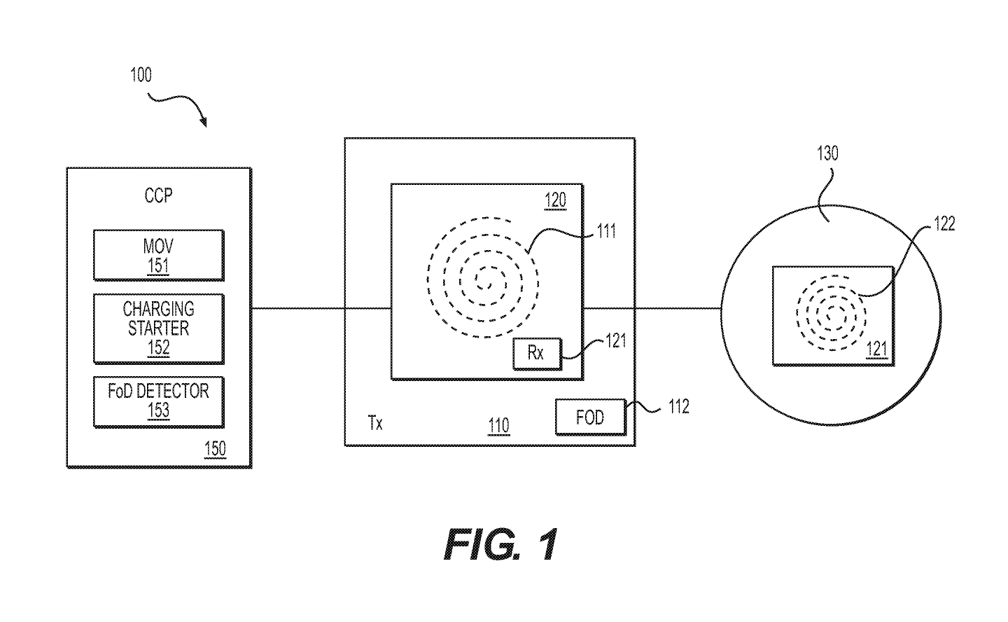

Inductive charging systems, such as those shown in FIG. 1, provide power in a wireless manner to electronic devices. As explained in the Background section, inductive charging systems are often included with foreign object detection techniques.

An issue with incorporating these foreign object detection techniques is that often times the conditions that trigger foreign object detection are triggered by moving the mobile device out of alignment. In an ideal charging situation, the transmission coil 111 and the reception coil 122 significantly aligned with each other. In situations where the coils are not aligned, the wireless charging is less efficient, and in certain cases, not possible.

As explained in the Background section, certain objects may trigger device detection to enable charging even when not charge-able. For example, certain metallic objects may appear to be chargeable due to their ability to affect the MoV signal. Thus, in these situations, the presence of these objects may cause the TX device 110 to determine if the device placed on the mat is chargable.

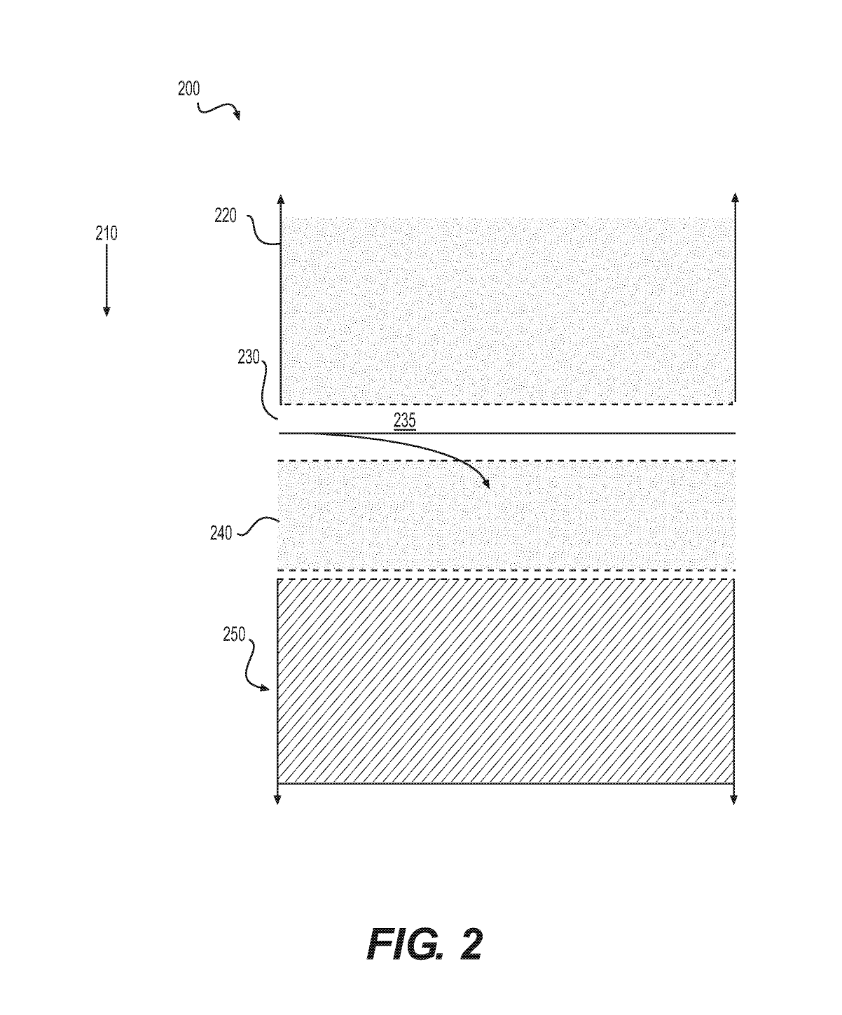

The foreign object detection algorithms employ a variety of methods to prevent a non chargeable object from triggering the Tx to charge. Once a foreign object is detected, the TX device 110 is configured to stop charging. A technique, which is explained with the graph 200 shown in FIG. 2, employs a maximum oscillation voltage (MoV).

As shown in the graph 200, a y-axis representing a detected MoV value is shown. In a system with a FoD implementation, the TX device 110 is configured to generate a short ping pulse periodically. The ping pulse generates a response, i.e. as noted by detected MoV. If the detected value of the MoV is within ranges 220 and 240, the TX device 110 determines that a foreign object (i.e. a device incapable of being charged) is placed on a wireless charging surface.

If the detected MoV value is within range 250, the device placed on the TX device 110 is determined to be a chargeable device (such as device 120). In that scenario, the MoV is unable to be read until charging is stopped, after which a ping is issued to generate an MoV, and the device 120 maintains an active wireless charging relationship with the TX device 110.

In certain cases, a foreign object may be placed on the device, and the MoV value detected may transition to ranges 220 or 240. Thus, until an indication is received by the user (i.e. switching power off and on to the Tx or the removal of the device and replacement), the TX device 110 is configured to not charge.

In some cases, the device 120 may move, and thus, cause the MoV detection to transition to ranges 220 or 240. Thus, a simple solution would be to allow the user to re-adjust the device 120 to a proper alignment. However, due to the limitations of existing FoD techniques, a user cannot perform this action. Thus, a user has to lift up their phone from the charging surface for a certain amount of time or cycle the power to commence charging again. This action may be onerous and in some cases, not safe (for example, when the TX device 110 is implemented in a vehicle).

Disclosed herein are systems and methods for facilitating re-alignment for an inductive charging system. The aspects disclosed herein may be implemented as stand-alone techniques, or used to modify existing inductive charging systems. By implementing the aspects discussed herein, the user experience associated with inductive charging improves.

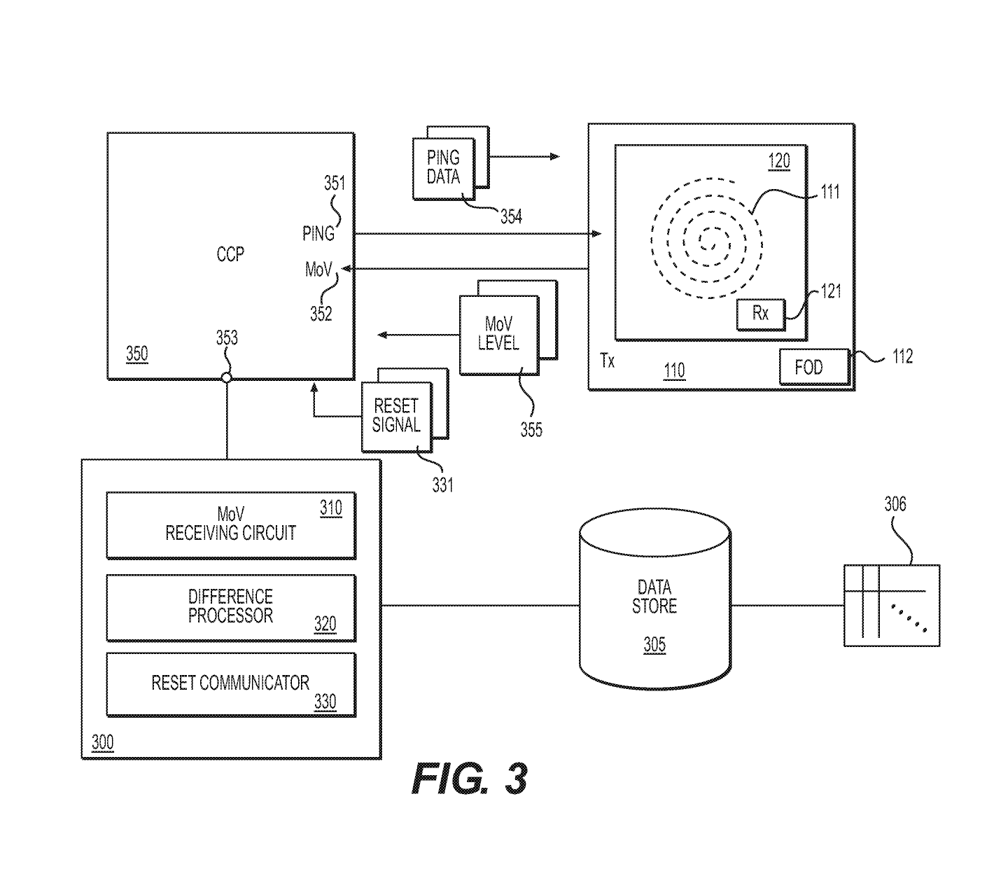

FIG. 3 illustrates an example of a system 300 for resetting an inductive charging device (TX device 110). The system 300 is shown with a microprocessor (charge control processor) 350 with instructions for generating waveforms, signals, and power coupling associated with a wireless/inductive charging of the TX device 110 to the device 120. The system 300 includes a MoV receiving circuit 310, a difference processor 320, and a reset communicator circuit 330. The system 300 may be provided as a stand-alone component, or alternatively, as an embedded circuit included in a charge control processor (CCP) 350.

The CCP 350 is shown modified to include interfaces associated with the addition of the system 300 (for example interface 353). The interface 353 allows for electrical coupling between the CCP 350 and the system 300.

CCP 350 includes a ping interface 351 (arrow in 351 should be going the other way from the CCP to the coil) and a MoV interface 352. Each of these interfaces serves as inputs/outputs that allow electrical connection with a TX device 110. The operation of these interfaces are similar to those explained in FIG. 1, and allow communication to/from the TX device 110. The ping interface 351 communicates ping data signals 354 to the TX device 110, which in turn, allows for the measuring of a MoV level 355.

The MoV receiving circuit 310 is configured to receive a MoV level 355 in response to an instruction receive the MoV level. The MoV level 355 may be equated with a predetermined table (stored in data store 305) associated with the alignment of the device 120.

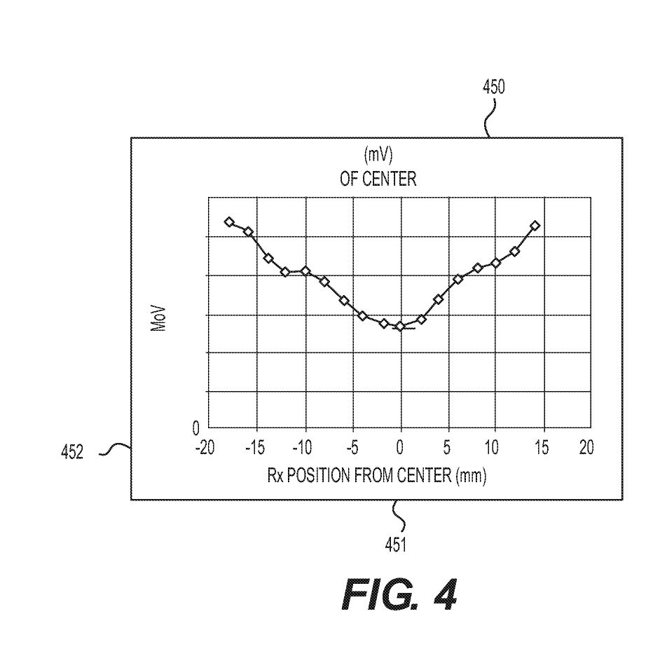

FIG. 4 illustrates an example of a lookup table 306 implemented with the system 300. As shown in the lookup table 306, the fields 401-403 are provided. The field 401 corresponds to a guide indicating whether the device 120 is either left of ideal alignment, centered, or right of the ideal alignment. The field 402 may indicate whether the device 120 is at a specific position associated with alignment. The field 403 indicates what the MoV value is associated with each position of alignment.

Graph 450 (the y-axis 452 corresponding to the MoV value, and the X-axis 451 corresponding to the field 402) show that as the device 120 is centered, the MoV value is lessened.

The example shown in FIG. 4 is just one way to use MoV value. As explained with the explanation in FIG. 3, MoV values may also be used with the implementation of a FoD detector 153.

With system 300, the MoV values are now used to determine whether to reset wireless charging. The difference processor 320 is configured to determine whether a difference is large enough in a stored MoV value versus a current measurement, and in turn, instigate a reset signal 331 via the reset communicator 330. The reset communicator is a system element capable of propagating a reset signal via interface 353 to the CCP 350. Accordingly, the CCP 350 is then configured to restart charging.

The system 300 may employ multiple ways of implementing the concepts disclosed herein. For example, methods 500 and 600 are two techniques provided to implement several of the core concepts disclosed herein. These two methods are described in greater detail below.

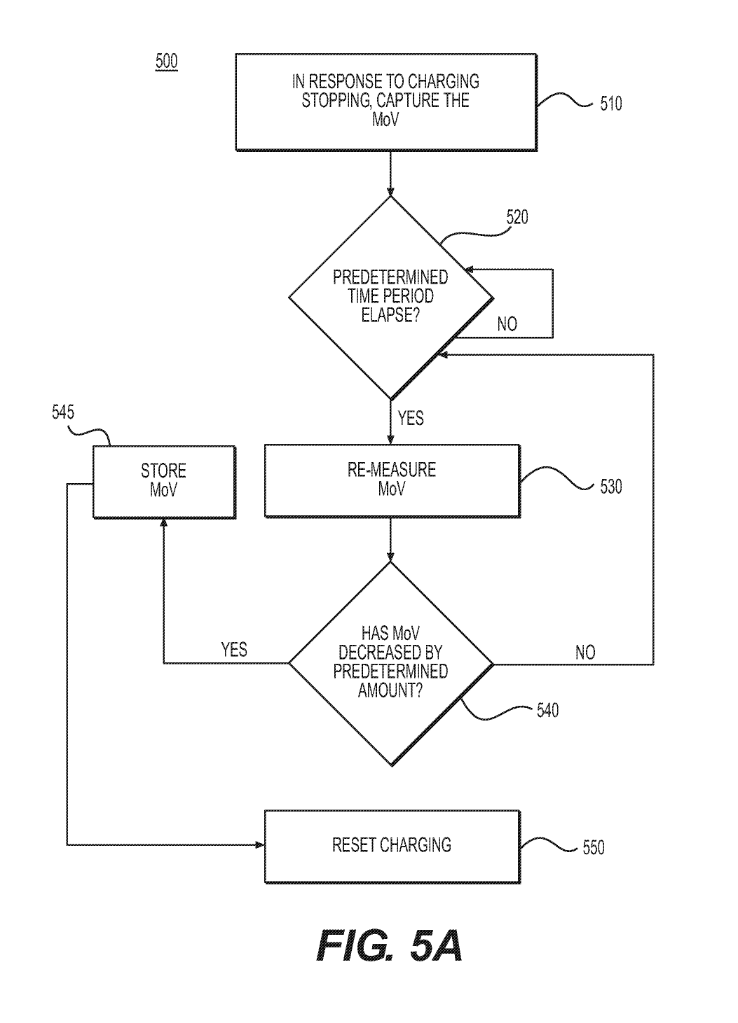

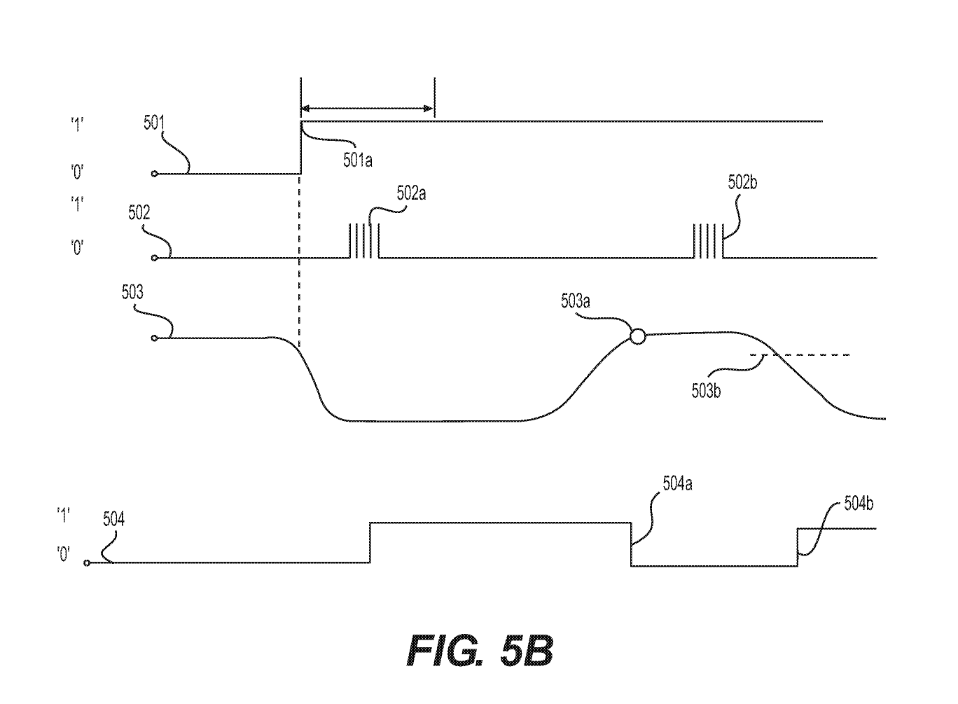

FIG. 5(a) illustrates an example of a method 500 for implementing the system 300 shown in FIG. 3. FIG. 5(b) illustrates a graphical representation of the method 500 for a sample case. The various signals are shown as dependent on time.

The waveforms in FIG. 5(b), illustrate an example implementation of the method 500, and will be explained in further detail along with the explanation of method 500. The waveforms in FIG. 5(b) are:

1) a foreign object on the mat (waveform 501), which changes from a ‘0’ to ‘1’ when a foreign object is detected based on a change in MoV;

2) a ping data signal 354 being generated (waveform 502), which is sent to a TX device 110 when the system 300 instigates a measurement associated with a foreign object. This concept is further exemplified with instigation of waveform 502 at point 502b after a foreign object is detected as shown at point 501a in waveform 501;

3) a MoV value associated with the TX device 110 (503); and

4) whether the charging is asserted, which changes from a ‘0’ to ‘1’ and vice versa to indicate whether charging is on or off (waveform 504).

In operation 510, in response to the charging being stopped (i.e., a TX device 110 detects that power stops transferring from the TX device 110 to the RX device 121), the MoV is captured and stored. At this juncture, for example, the MoV receiving circuit 310 may receive the captured MoV level 355.

As shown in FIG. 5(b), this is denoted on waveform 504's transition from ‘1’ to ‘0’ at point 504a. Also shown is point 503a, which is the value the MoV is at point 504a. This value of the MoV level 355 is stored.

In operation 520, a waiting period occurs. A determination is made as to whether a predetermined time period elapses. If no, the method 500 remains at operation 520, and iteratively performs again. If yes, the method 500 proceeds to operation 530.

In operation 530, the MoV is re-measured (for example, received again by the MoV receiving circuit 310). After which, a determination is made as to whether the MoV has decreased by a predetermined amount (operation 540). If no, the method 500 iteratively preforms the above-stated tasks again. The method 500 proceeds to operation 545, where the MoV level 355 is stored.

If yes for the determination in operation 540, the method 500 proceeds to operation 550. For example, if the value difference of the value at 503b versus the value at 503a is over a specific predetermined threshold, the method 500 proceeds to operation 550. As such, charging is reset. As explained, prior to the method 500 discussed above, with CCP 350 employing FoD techniques, a user would manually have to indicate that the foreign object was off the charger, or in some cases, lift up the device 120 (stop charging), and remove anything on the Tx surface and re-place the device 120 on the TX device 110's surface.

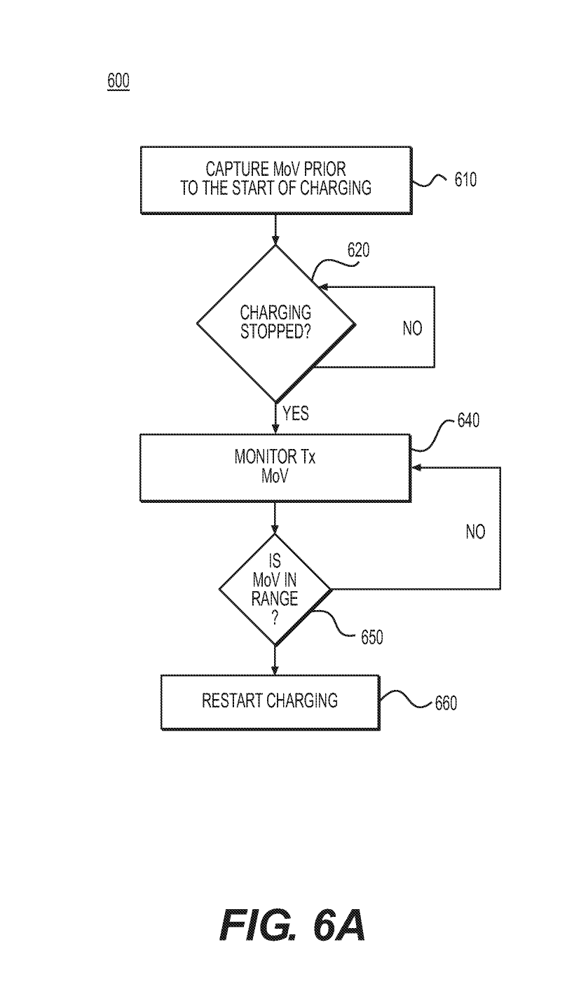

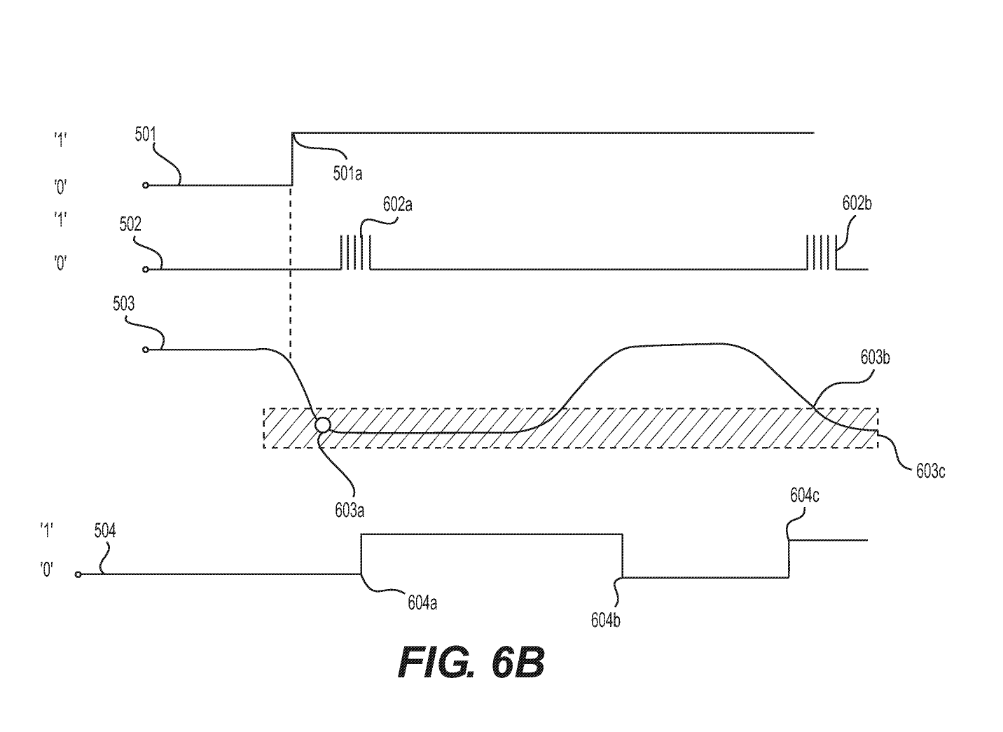

FIG. 6(a) illustrates another method 600 for implementing the aspects disclosed in system 300. The various elements of system 300 may be configured or designed employing standard circuit-based technologies to perform the operations of method 600.

In FIG. 6(b), the waveforms 501-504 are also used, and thus, the explanation employed above is duplicated for the waveforms shown in FIG. 6(b).

In operation 610, the MoV is captured as charging commences (thus, as the TX device 110 receives an indication that charging is about to commence, or has commenced, an instruction is sent to system 300 to capture and store the MoV level 355 associated with charging.

In FIG. 6(b), at point 604a (on waveform 504), the TX device 110 is instructed to commence charging. As the TX device 110 is charging a device 120, the MoV level 355 at point 603a is measured. A measurement is created based on ping data signal 354 at point 602a being generated.

In operation 620, a determination is made as to whether charging has stopped (i.e. from an indication that a foreign object is on the TX device 110). As such, if no, the method 600 remains at operation 620. If yes, the method 600 proceeds to operation 630. This is indicated at point 604b on waveform 504.

In operation 630, a ping idle state is entered into (as shown in FIG. 6(b) with the assertion of ping data signal 354 at 602b). As such, the CCP 350 is configured and instructed to generate a ping data signal 354 to the TX device 110. In response, the MoV is captured and stored at point 603b.

In operation 650, a determination is made as to whether the MoV level 355 at 603b is within a predefined range from the stored MoV in operation 610 (the range is indicated in FIG. 6(b) as range 603c). If yes, the method 600 proceeds to operation 660 and restarts charging (point 604c). Alternatively, the method 600 proceeds to operation 640 and iteratively keeps performing operations 640 and 650 until the MoV level 355 is in the predetermined range.

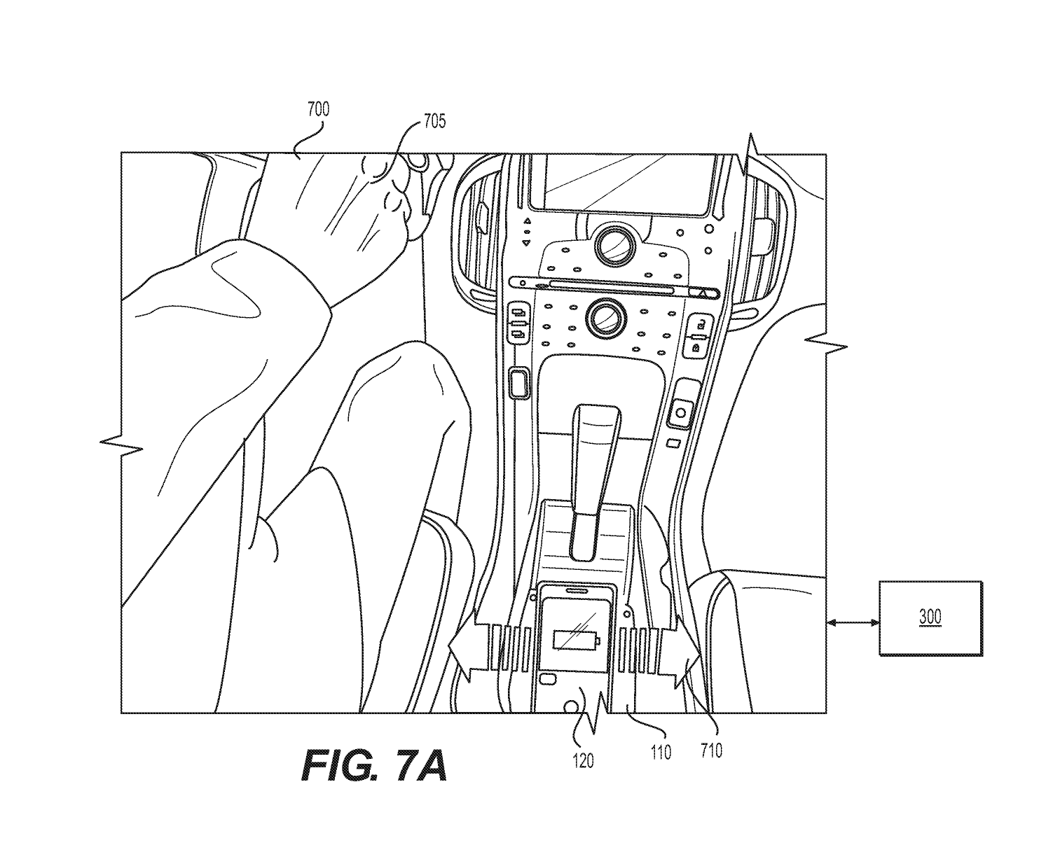

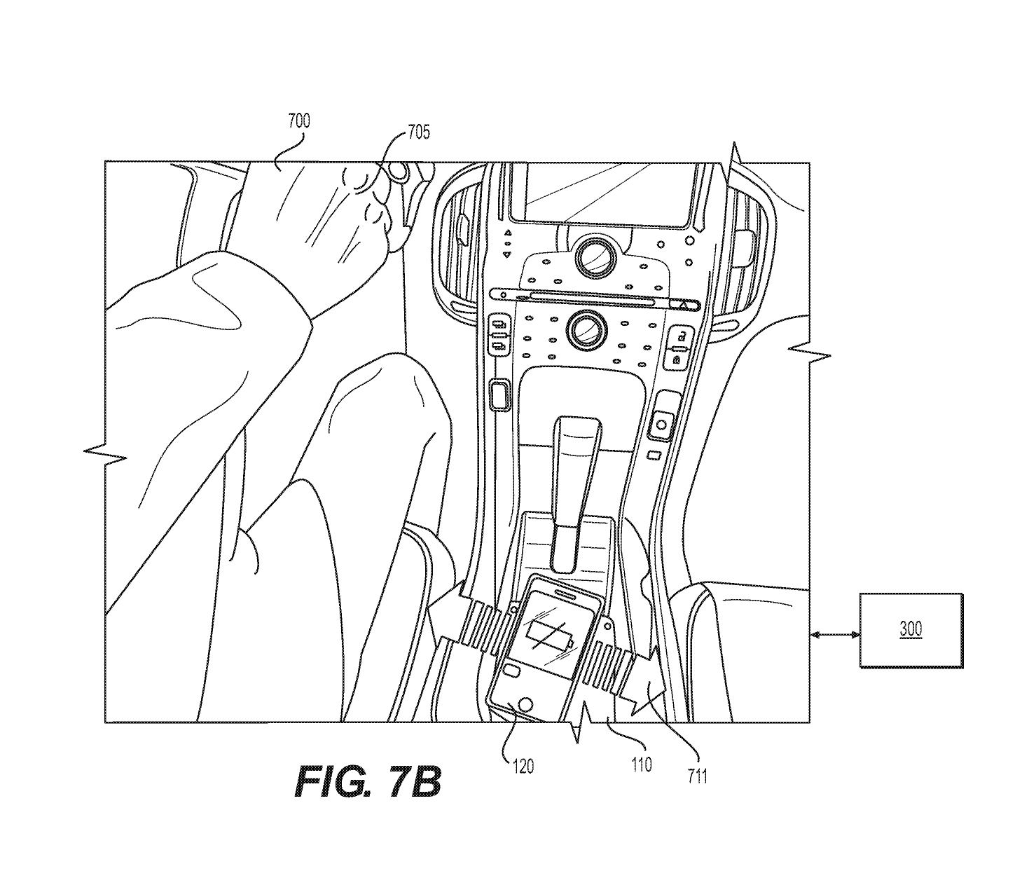

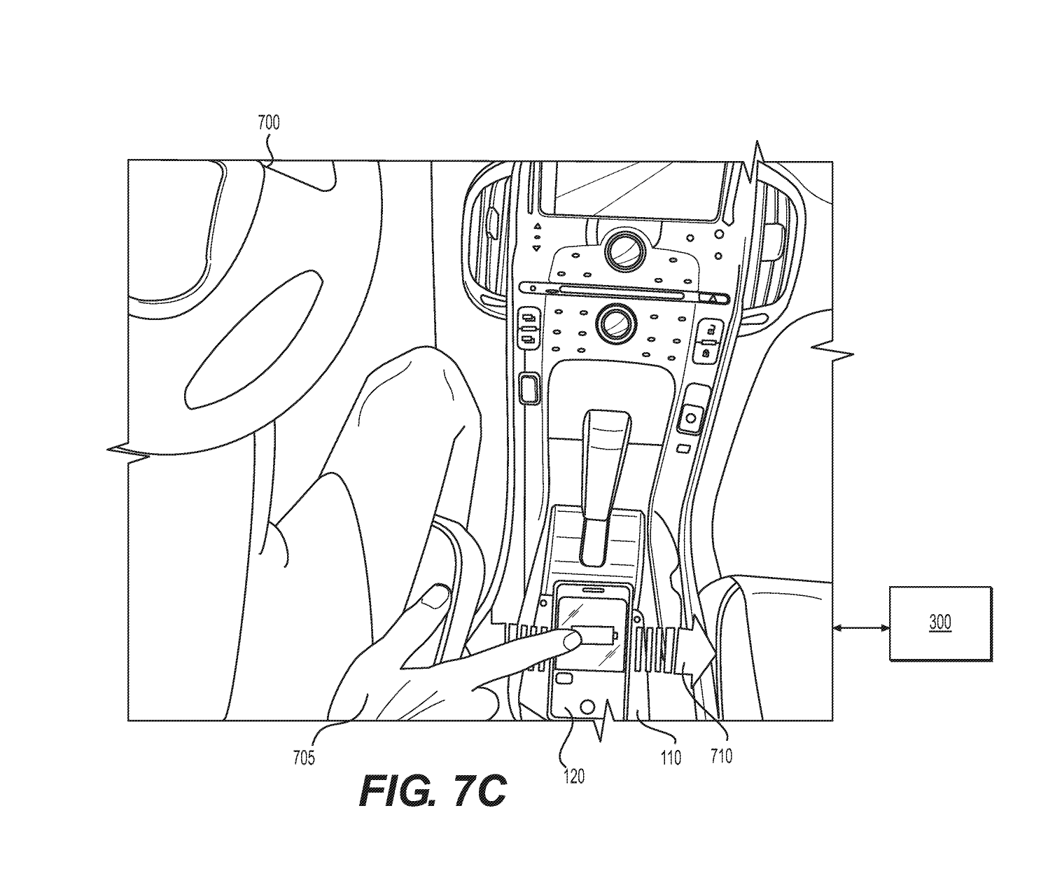

FIGS. 7(a)-(c) illustrate an example of an implementation 700 of the concepts discussed above. The implementation 700 incorporates system 300, which is wired or electrically coupled to the TX device 110 shown. The implementation 700 is shown in a vehicular setting. However, the TX device 110 may be implemented in other contexts and environments.

As shown in FIG. 7(a), the device 120 (which includes a RX device 121) is placed over a surface of a TX device 110. The orientation is 710, which indicates alignment with the TX device 110. Thus, as shown in the screen of device 120, the charging is occurring normally.

In FIG. 7(b), the device 120 has significantly moved, and is now at orientation 711. As shown, the device 120 is no longer charging (as indicated by the shown graphic on device 120), and a FoD indication is made (due to the misalignment triggering this feature).

Prior to the aspects disclosed herein, a user would have to toggle a switch or lift the device 120 off the TX device 110. However, employing the aspects disclosed herein, a user merely has to use their hands 705 (or any appendage/object), and slide the device 120 back to orientation 710 (as shown in FIG. 7(c)). Thus, the charging occurs again independent any other action.

Certain of the devices shown include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

The preceding disclosure refers to a number of flow charts and accompanying descriptions to illustrate the embodiments represented in FIGS. 5(a) and 6(a). The disclosed devices, components, and systems contemplate using or implementing any suitable technique for performing the steps illustrated in these figures. Thus, FIGS. 5(a) and 6(a) are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scanable features, and other features that can receive human inputs.

The computing system disclosed herein can include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for resetting an inductive charging device, comprising:
a maximum oscillation voltage (MoV) circuit configured to calculate an MoV measurement from the inductive charging device;
a difference processor configured to detect a difference from an initial MoV measurement and a subsequent MoV measurement from the MoV circuit;
a reset communication configured to electrically communicate a reset signal to the inductive charging device based on the detected difference, wherein:
the inductive charging device is communicatively coupled to a charge controlling processor (CCP), the CCP including a foreign object detection circuit configured to detect a foreign object placed on the inductive charging device based on the MoV measurement,
the inductive charging device is configured to charge a receiving device in response to the receiving device being in alignment,
and the inductive charging device is configured to stop charging the device based on gross mis-alignment and/or the detection of a foreign object.

2. The system according to claim 1, wherein the initial MoV measurement occurs in response to a measurement based on a detection that inductive charging is stopped, and the subsequent MoV measurement occurs a predetermined time after the initial MoV measurement occurs.

3. The system according to claim 1, wherein the initial MoV measurement occurs in response to the inductive charging commencing, and the subsequent MoV measurement occurs after a predetermined time associated with a stopping of the inductive charging.

4. The system according to claim 1, wherein the system is implemented onto a charge control processor.

5. The system according to claim 1, wherein a ping signal is communicated to the inductive charging device to instigate the initial MoV measurement.

6. The system according to claim 1, wherein the system is implemented in an environment where the inductive charging device may be moved t.

7. A method for resetting an inductive charging device, comprising:
in response to the inductive charging device stopping an act of charging, capturing a maximum oscillation voltage (MoV) amount and storing it as an initial value;
waiting for a predetermined time period to elapse;
after the predetermined time period has elapsed, capturing a subsequent MoV level;
in response to a difference between initial stored MoV level and the subsequent MoV level being over a predetermined amount, communicating a signal indicating a reset charging of the inductive charging device.

8. The method of claim 7, wherein the method is implemented in an environment where the inductive charging device may be moved.

9. The method of claim 7, wherein the method is implemented on a charge controlling processor.

10. The method of claim 7, wherein the inductive charging device is configured to stop the act of charging based on an indication that a foreign object is detected.

11. A method for resetting an inductive charging device, comprising:
capturing an initial maximum oscillation voltage (MoV) amount and storing it in response to the inductive charging device starting charge of a device capable of receiving wireless charging;
determining whether the inductive charging device stops an act of charging the device;
instigating a ping signal to the inductive charging device;
monitoring the inductive charging device's subsequent MoV level after the ping signal is instigated;
determining whether a range defined by the initial stored MoV level and the subsequent MoV level is in a predetermined range, and in response to the range being within the predetermined range, communicating a restart charging signal to the inductive charging device to try to re-establish charging.

12. The method according to claim 11, wherein in response to the determination that range is not within the predetermined range, iteratively performing the monitoring and the determining after a predetermined time period.

13. The method of claim 11, wherein the method is implemented in an environment where the inductive charging device may be moved.

14. The method of claim 11, wherein the method is implemented on a charge controlling processor.

15. The method of claim 11, wherein the inductive charging device is configured to stop the act of charging based on an indication that a foreign object is detected.
